(19) United States
(12) Patent Application Publication
(10) Pub. No.: US 2020/0181963 A1
(43) Pub. Date: Jun. 11, 2020

(54) HINGE ASSEMBLY WITH SEPARATE SPRING ASSEMBLY

(71) Applicant: Magna BÖCO GmbH, Wuppertal (DE)

(72) Inventors: Michael DIGEL, Wuppertal (DE); Ulrich Maak, Erkrath (DE)

(21) Appl. No.: 16/704,386

(22) Filed: Dec. 5, 2019

Related U.S. Application Data
(60) Provisional application No. 62/775,619, filed on Dec. 5, 2018.

(51) Int. Cl. E05F 1/12; E05D 3/14; F16F 1/06

(52) U.S. Cl. CPC E05F 1/1207; E05D 3/147; F16F 1/065; E05Y 2900/548; E05Y 2201/484; E05Y 2900/536; E05Y 2800/45

(57) ABSTRACT

A spring assembly of a hinge assembly for a closure panel of a vehicle, the spring assembly comprising: a spring support bracket for connecting to a bracket of the hinge assembly; a spring mounted on the spring support bracket, the spring having an output end, the spring for biasing operation of the hinge assembly in order to move the closure panel towards an open position, the spring assembly including a holder mounted on the spring support bracket such that the holder is movable between an engaged position with the output end and a disengaged position with the output end; wherein when the output end is engaged with input end, the spring assembly is mountable to the hinge assembly.

### CROSS-REFERENCE TO RELATED APPLICATION

This application claims priority from the benefit of the filing date of U.S. Provisional Patent Application No. 62/775,619 filed on Dec. 5, 2018, entitled “HINGE ASSEMBLY WITH SEPARATE SPRING ASSEMBLY”, the contents of which are herein incorporated by reference.

### FIELD

The present disclosure relates to closure panel hinge systems.

### BACKGROUND

Hinge assemblies for closure panels, such as vehicle hood and deck lids, are mounted to the vehicle body prior to painting. This assembly procedure prior to painting can present disadvantages, as the hinge assemblies can have plastic parts that can become damaged by the painting process, or are otherwise incompatible with the paint. Further, temperatures experienced by the hinge assembly during painting can result in damage to the integrity of springs included in the spring assembly.

Further, it is recognized that during assembly of the hinge assembly, accommodation of tolerances can be difficult.

### SUMMARY

It is an object of the present invention to provide a hinge assembly to obviate or mitigate at least some of the above-presented disadvantages.

A first aspect provided is a hinge assembly for a closure panel of a vehicle, the hinge assembly comprising: a first hinge portion for connecting to a body of the vehicle; a second hinge portion for connecting to the closure panel, the second hinge portion pivotally connected to the first hinge portion by a joint; a set of levers coupling a spring to the second hinge portion, the set of levers having a lever input end; a spring assembly for mounting on the first hinge portion, the spring assembly including the spring having an output end, the spring for biasing the second hinge portion away from the first hinge portion in order to move the closure panel towards an open position, the spring assembly including a holder for controlling engagement and disengagement of the output end with the lever input end; wherein when the output end is disengaged from the lever input end by the holder, the spring assembly is removable from the first hinge portion.

A second aspect provided is a spring assembly of a hinge assembly for a closure panel of a vehicle, the spring assembly comprising: a spring support bracket for connecting to a bracket of the hinge assembly; a spring mounted on the spring support bracket, the spring having an output end, the spring for biasing operation of the hinge assembly in order to move the closure panel towards an open position, the spring assembly including a holder mounted on the spring support bracket such that the holder is movable between an engaged position with the output end and a disengaged position with the output end; wherein when the output end is engaged with input end, the spring assembly is mountable to the hinge assembly.

A third aspect provided is a method for assembling a hinge assembly including the steps of: mounting a spring assembly onto a body bracket of the hinge assembly, the spring assembly having a spring mounted on a spring support bracket, the spring having an output end, the spring for biasing operation of the hinge assembly in order to move the closure panel towards an open position, the spring assembly including a holder positioned on the spring support bracket at a pre-position inhibiting engagement of the output end with a lever input end of the hinge assembly; moving the holder on the spring support bracket from the pre-position to an operational position in order to engage the output end with the lever input end; wherein subsequent movement of the hinge assembly is facilitated by said engage of the output end with the lever input end.

A fourth aspect provided is a hinge assembly for a closure panel of a vehicle, the hinge assembly comprising: a first hinge portion for connecting to a body of the vehicle; a second hinge portion for connecting to the closure panel, the second hinge portion pivotally connected to the first hinge portion by a joint; a set of levers coupling a spring to the second hinge portion, set of levers being interconnected by joints without tolerances in a lateral direction, the set of levers having a lever input end projecting in the lateral direction; and a spring assembly mounted on the first hinge portion, the spring assembly including the spring having an output end, the spring for biasing the second hinge portion away from the first hinge portion in order to move the closure panel towards an open position, the spring assembly including a holder for controlling engagement and disengagement of the output end with the lever input end

### BRIEF DESCRIPTION OF THE DRAWINGS

The foregoing and other aspects will now be described by way of example only with reference to the attached drawings, in which:

FIG. 1 is a perspective view of a vehicle body with closure panel attached by way of one or more hinge assemblies;

FIG. 2 is an exploded view of a spring assembly of the hinge assembly of FIG. 1;

FIG. 3 is an exploded view of hinge portions of the hinge assembly of FIG. 1;

FIG. 4 is an assembled view of the spring assembly with the hinge portions in a closed position of the hinge assembly of FIG. 1;

FIG. 5 is an assembled view of the spring assembly with the hinge portions in an open position of the hinge assembly of FIG. 1;

FIG. 6 is an assembled view of the spring assembly with the hinge portions in the open position and the spring assembly in a pre-position of the hinge assembly of FIG. 1;

FIG. 7 is an assembled view of the spring assembly with the hinge portions in the open position and the spring assembly in an operational position of the hinge assembly of FIG. 1;

FIG. 8 is a perspective view of a holder of the spring assembly of FIG. 2;

FIGS. 9a, 9b, 9c are operational examples of the hinge portions of the hinge assembly of FIG. 1;

FIGS. 10a, 10b, 10c show various assembly steps of the hinge assembly of FIG. 1;

FIG. 11 shows the hinge assembly of FIG. 1 in an operational position;

FIG. 12 shows tolerance adjustment ability of the hinge assembly of FIG. 1;

FIGS. 13 and 14 show perspective views of the spring assembly in isolation; and

FIG. 15 is a method for assembling and disassembling of the hinge assembly of FIG. 1.

### DETAILED DESCRIPTION

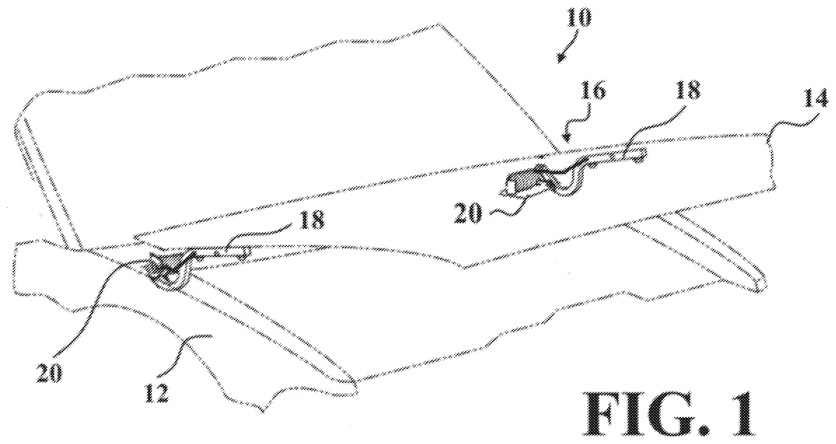

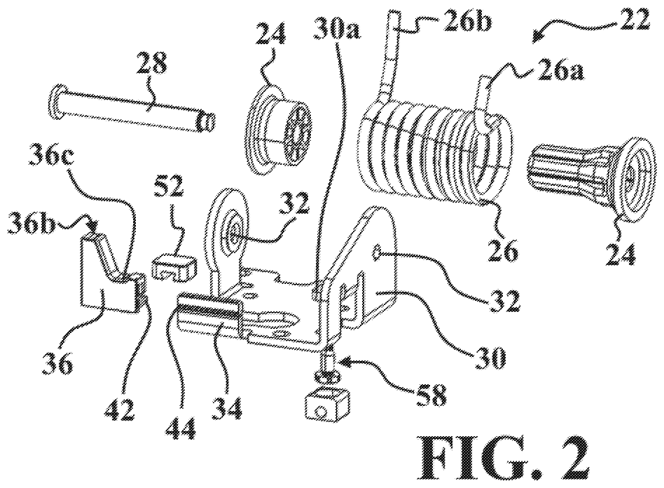

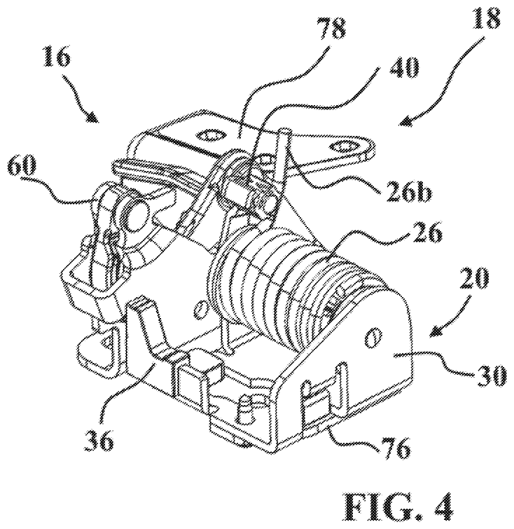

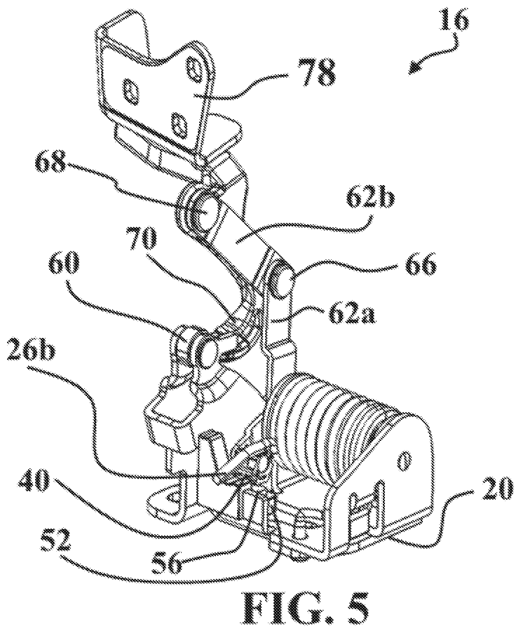

Referring to FIG. 1, shown is a vehicle 10 having a body 12 with a closure panel 14 (e.g. a trunk lid) in ghosted view, such that the closure panel 14 is connected to the body 12 via one or more hinge assemblies 16. The hinge assembly 16 has a first hinge portion 20 attached to the body 12 and has a second hinge portion 18 attached to the closure panel 14. A further spring assembly portion 22 (see FIG. 2) is mounted on either the first hinge portion 20 or the second hinge portion 18, recognizing that the mounting embodiment of on the first hinge portion 20 is shown in FIG. 1. It is recognized that the first hinge portion 20 is assembled to the body 12 and the second hinge portion 18 is assembled to the body 12 and/or closure panel 14 prior to painting. It is preferred that the spring assembly portion 22 is mounted as part of the hinge assembly 16 after the painting has been performed, as coating temperatures (e.g. approximately 200 degrees Celsius) can damage the spring as well as other plastic components of the spring assembly portion 22, as further described below. It is recognised that the spring assembly portion 22 can also be referred to as a drive assembly 22 for the hinge assembly 16, such that the drive assembly 22 can be releasably attached to both of the first hinge portion 20 and the second hinge portion 18. It is this drive assembly 22 (including a spring 26) that can be connected to the first hinge portion 20 and the second hinge portion 18 subsequent to painting of the first 20 and second 18 hinge portions. Further, as described below, it is operation of the drive assembly 22 (once connected) that facilitates movement of the first hinge portion 20 relative to the second hinge portion 18 during operation of the hinge assembly 16, i.e. providing the force for opening of the closure panel 14 (see FIGS. 4 and 5).

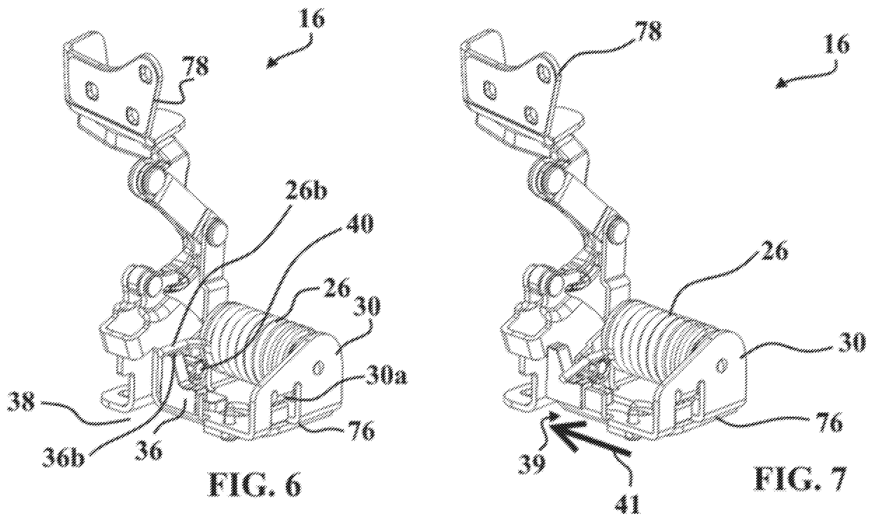

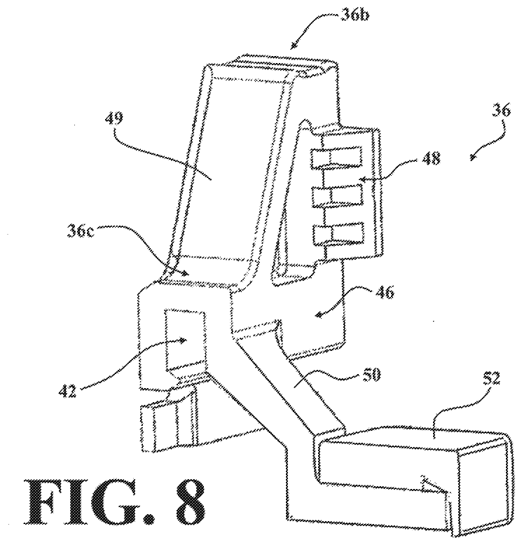

Referring to FIG. 2, shown is the spring assembly portion 22 having a pair of sleeves 24 for mounting the spring 26 on a support rod 28. The spring 26 is mounted on a spring support bracket 30 via the support rod 28, as inserted and retained in mounting holes 32 of the spring support bracket 30. The sleeves 24 facilitate the rotation of the spring 26 about the support rod 28, as the hinge assembly 16 is moved between an open position (see FIG. 5) and a closed position (see FIG. 4). The spring support bracket 30 can also have a holder mount 34 for mounting a holder 36, which can be moved from a pre-position, see FIG. 6, and a normal (or operational position), see FIG. 7.

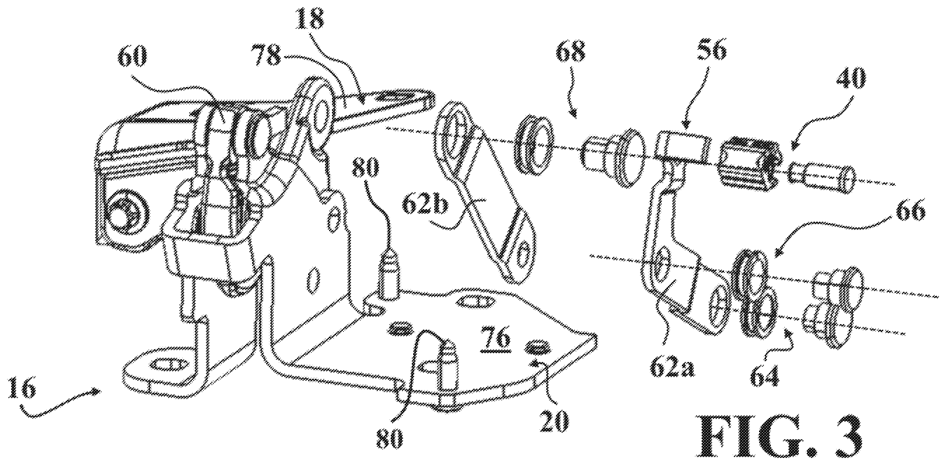

The spring 26 has an input end 26a mounted on the spring support bracket 30 at tab 30a. The spring 26 also has an output end 26b that is coupled with a lever input end 40 (see FIGS. 3,5) when the hinge assembly 16 is in the operational position (see FIG. 7) and is disconnected with the lever input end 40 and thus engaged with an assembly tab 36b of the holder 36 when the hinge assembly 16 is in the pre-position (see FIG. 6). The holder 36 also has an operational tab 36c, whereby the lever output end 40 is positioned (for example in noncontact therewith) adjacent thereto when the hinge assembly 16 is in the operational position (see FIG. 7). As such, as further described below, the location of the output end 26b with respect to the holder 36, is either adjacent to (e.g. and not supported by or not in contact with) the operational tab 36c or is adjacent (e.g. and supported by and thereby in contact with) the assembly tab 36b. Hence the holder 36 has a pre-position 38 on the holder mount 34 (see FIG. 6) and an operational position 39 (see FIG. 7), such that the holder 36 can move between the pre-position 38 and the operational position 39 (e.g. via slot 42 of the holder 36 engaged with a track 44 of the holder mount 34. The spring assembly 22 can also have a spring adjustment mechanism 58, e.g. a set screw, for adjusting the strength of the spring 26 (e.g. torsion of the spring) by variably setting (e.g. twisting the body of the spring 26) the position of the spring input end 26a.

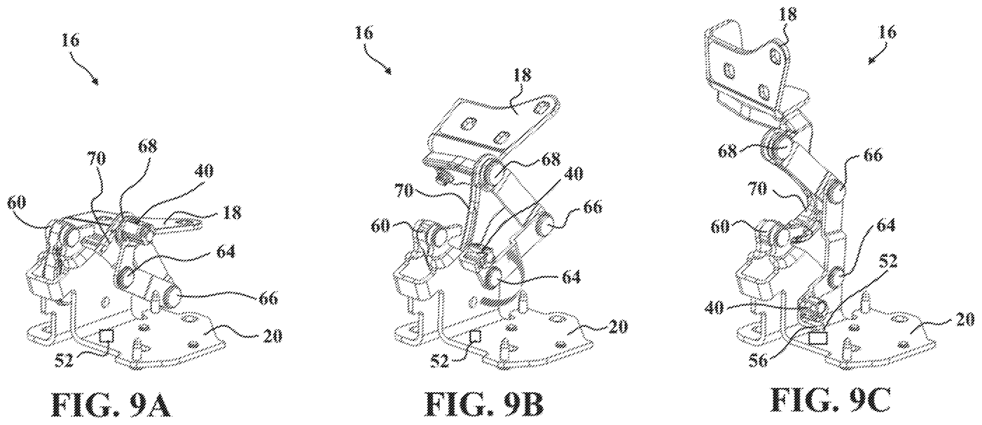

Referring to FIG. 8, shown is the holder 36 in isolation, having a body 46 with the slot 42, the operational tab 36c and the pre-position tab 36b. The body 46 can also had a push tab 48 for facilitating moving the holder 36 between the operational position 39 and the pre-position tab 38. The body can also have a ramp 49 for facilitating moving of the output end 26b of the spring 26 between the tabs 36b,c. The body 46 can also have an arm 50 for supporting a resilient element 52 (e.g. rubber pad), such that the resilient element is positioned adjacent to and in line with an end stop portion 56 of the lever input end 40 (see FIGS. 3 and 5). For example, when the hinge assembly 16 is in the open position (e.g. the closure panel 14 is in the open position—see FIG. 1), the end stop portion 56 can come into contact with the resilient element 52 (shown in ghosted view), realizing that the holder 36 is positioned in the operational position 39—see FIG. 5. The resilient element 52 has the advantage of inhibiting noise and wobbling/rebound behavior of the closure panel 14.

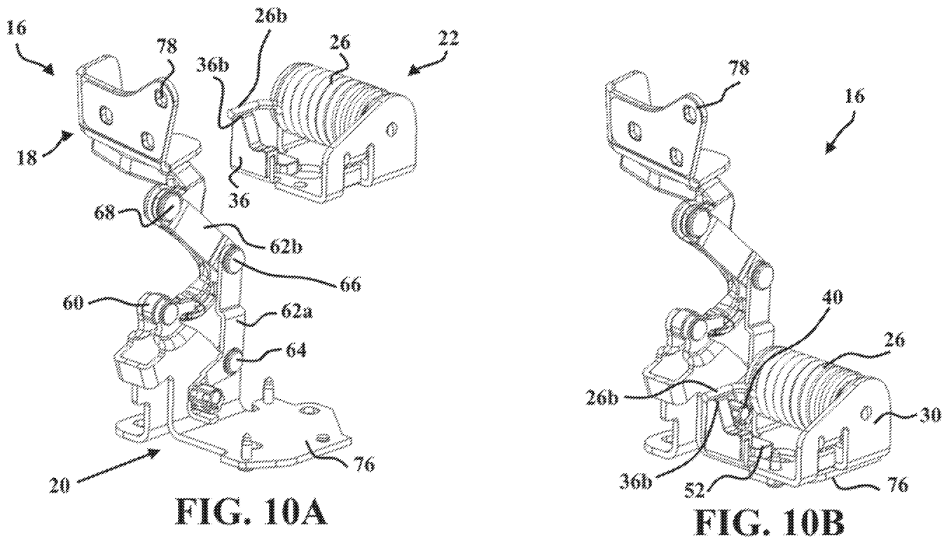

Referring to FIGS. 3,5, the hinge assembly 16 has the first hinge portion 20 and the second hinge portion 18 connected to one another at joint 60, such that the second hinge portion 18 moves relative to the first hinge portion 20 about the joint 60 (see FIGS. 9a, 9b, 9c). Further, the spring 26 of the spring assembly portion 22 is connected to the second hinge portion 18 via one or more levers 62, e.g. a first lever 62a and a second lever 62b. The first lever 62a has the lever input end 40 with the end stop portion 56. The first lever 62a is pivotally connected at one end via joint 64 with the first hinge portion 20, the second lever 62b is pivotally connected at one end to another end of the first lever via joint 66, and the second lever 62b is pivotally connected at another end via joint 68 to the second hinge portion 18, such that the joint 60 and the joint 68 are spaced apart from one another along a body arm 70 of the second hinge portion 18. As noted, during operation of the hinge assembly 16, the input end 26b of the spring 26 is used to bias the lever input end 40 towards the resilient element 52 (shown in ghosted view—see FIGS. 9a, 9b, 9c), as the closure panel 14 (see FIG. 1) moves from the closed position of FIG. 9a to the intermediate open position of FIG. 9b to the open position of FIG. 9c.

Referring again to FIG. 3, the first hinge portion 20 has a body bracket 76 for connecting the hinge assembly 16 to the body 12 (see FIG. 1) and the second hinge portion 18 has a panel bracket 78 for connecting the hinge assembly 16 to the closure panel 14. The body bracket 76 has mounting locations 80 (e.g. pins) for mounting the spring support bracket 30 thereon (see FIGS. 3, 5). As such, the body arm 70 connects the panel bracket 78 to the joint 60.

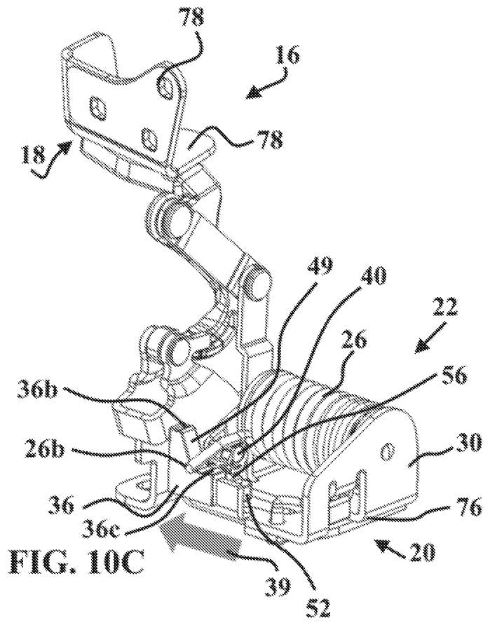

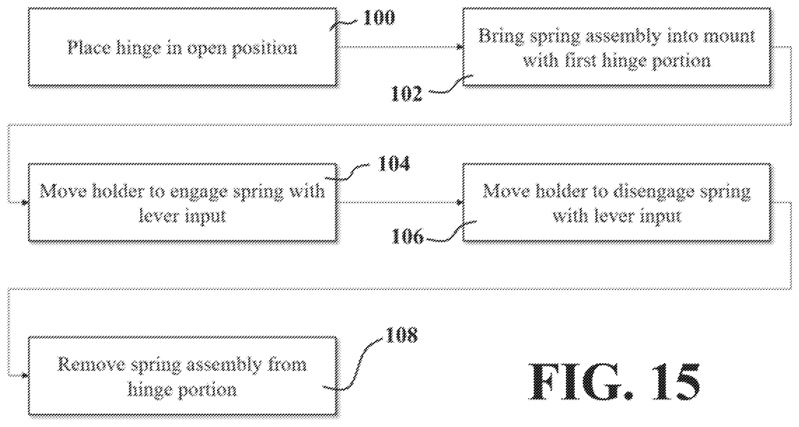

Referring to FIGS. 10a, 10b, 10c, and FIG. 15, when the closure panel 14 (see FIG. 1) is in the open position, at step 100. At step 102, the spring assembly 22 is brought into contact with and mounted on the first hinge portion 20, i.e. the spring support bracket 30 is mounted on the body bracket 76, as shown by FIGS. 10a and 10b. It is noted that at step 102, the input end 26b is resting and therefore in contact with the pre-position tab 36b. Further, when the spring assembly 22 is mounted on to the body bracket 30, see FIG. 10b, the resilient element 52 is positioned out of line with the lever input end as the holder 36 is in the pre-position 38 (see FIG. 6). It is recognized that when the input end 26b is in contact with the pre-position tab 36b, the input end 26b is also out of contact with the lever input end 40 (i.e. the input end 26b and the lever input end 40 are decoupled from one another).

At step 104, the holder 36 is moved from the pre-position 38 to the operational position 39 along the track 44 of the holder mount 34, see FIGS. 2 and 10c. This change in position of the holder 36 provides for the input end 26b of the spring 26 to move from the pre-position tab 36b to the operational tab 36c, for example down the ramp 49, as well as the resilient element 52 to become positioned in line with the end stop portion 56 of the lever input end 40. In the operational position, the input end 26b is engaged (i.e. coupled) to the lever input end 40, such that the lever input end 40 is now biased towards the closure panel open position (see FIG. 1). It is noted that FIG. 10c also provides for illustration of the disassembly of the spring assembly 22 from the first hinge portion 20, i.e. such that at step 106 the holder 36 is moved from the operational position 39 back to the pre-position 38 (see FIG. 10b), such that the input end 26b moves from the operational tab 36c and back up the ramp 49 to become engaged with the pre-position tab 36b. At step 108, the spring assembly 22 can now be removed from the first hinge portion 20, see FIG. 10a.

It is noted that when the input end 26b is in contact with the pre-position tab 36b of the holder 36, the input end 26b is disengaged (i.e. out of contact with) from the lever input end 40. In view of the above, the spring 26 can be regarded as a torsion spring, such that moving of the closure panel 14 from the closed position to the open position (see FIGS. 9a, 9b, 9c) allows the spring 26 to unload. Conversely, moving of the closure panel 14 from the open position to the closed position (see FIGS. 9a, 9b, 9c) allows the spring 26 to load.

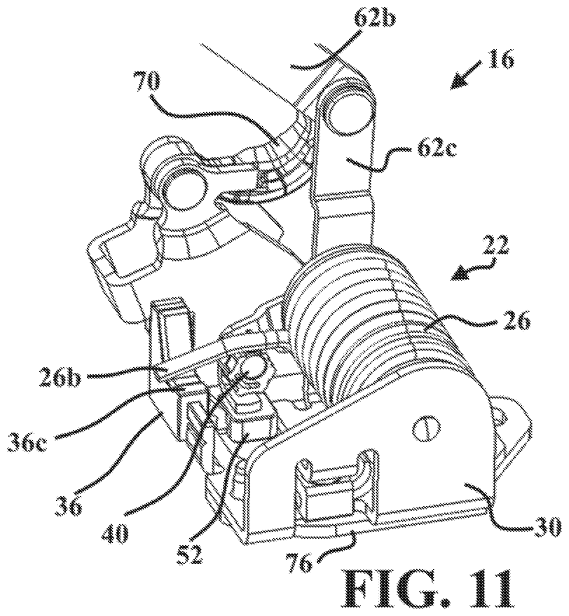

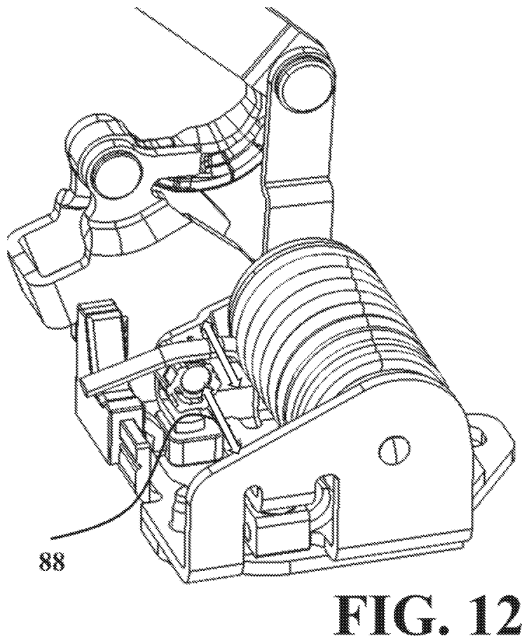

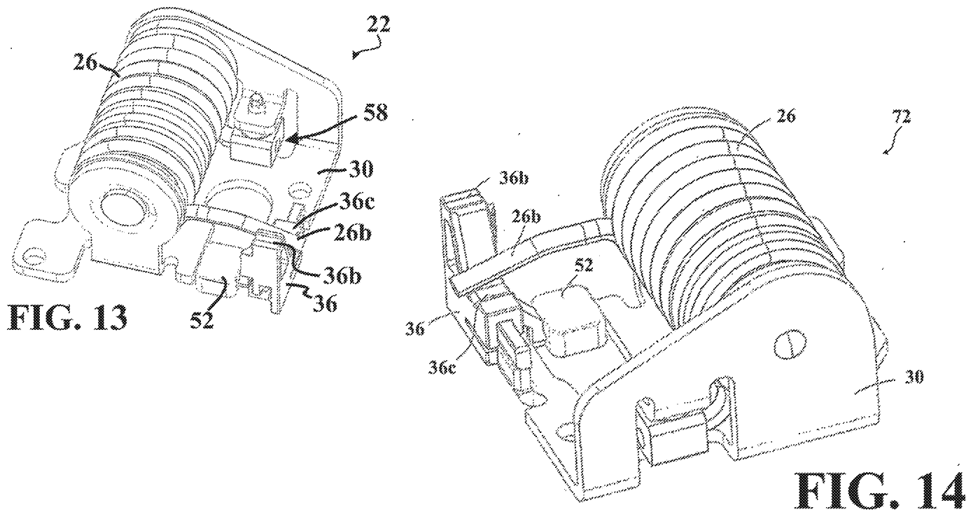

Referring to FIG. 11, shown is the input end 26b engaged with the lever input end 40 and thus disengaged with the holder 36. Referring to FIG. 12, shown is where movement 88 in the Y direction, e.g. side to side within the spring support bracket 30, thus facilitating adjustment in tolerances during the assembly. In particular, the position of the resilient element 52 and the position of the lever input end 40 can be moved laterally (movement 88) relative to one another in order to facilitate the adjustment in tolerances. The movement 88 can be in a direction similar to movement of the holder 36 between the pre-position 38 and the operational position 39. Referring to FIG. 13 and FIG. 14, illustrated in isolation is the spring assembly 22 in the operational position. Further, referring to FIGS. 13 and 14, as the resilient element 52 is not under the spring adjustment mechanism 58, assembly of the drive assembly 22 onto the hinge portions 18,20 is facilitated.

We claim:

1. A hinge assembly for a closure panel of a vehicle, the hinge assembly comprising:
a first hinge portion for connecting to a body of the vehicle;
a second hinge portion for connecting to the closure panel, the second hinge portion pivotally connected to the first hinge portion by a joint;
a set of levers coupling a spring to the second hinge portion, the set of levers having a lever input end;
a spring assembly for mounting on the first hinge portion, the spring assembly including the spring having an output end, the spring for biasing the second hinge portion away from the first hinge portion in order to move the closure panel towards an open position, the spring assembly including a holder for controlling engagement and disengagement of the output end with the lever input end;
wherein when the output end is disengaged from the lever input end by the holder, the spring assembly is removable from the first hinge portion.

2. The hinge assembly of claim 1, wherein the holder is mounted on a holder mount of a spring support bracket of the spring assembly, the holder is movable between a pre-position in which the output end is said disengaged and an operational position in which the output end is said engaged.

3. The hinge assembly of claim 2, wherein the holder is mounted on the spring support bracket by a slot and track arrangement.

4. The hinge assembly of claim 3, wherein the slot is positioned on the holder and the track is positioned on the holder mount, such that movement of the slot along the track facilitates movement of the holder between the pre-position and the operational position.

5. The hinge assembly of claim 1 further comprising the holder having a pre-position tab and an operational tab, such that positioning of the output end on the pre-position tab results in said disengagement and positioning of the output end adjacent the operational tab results in said engagement.

6. The hinge assembly of claim 5 further comprising a ramp separating the pre-position tab from the operational tab.

7. The hinge assembly of claim 1 further comprising a spring adjustment mechanism for adjusting a position of an input end of the spring.

8. The hinge assembly of claim 1 further comprising a resilient element coupled to the holder, the resilient element for positioning in line with an end stop portion of the lever input end.

9. The hinge assembly of claim 1, wherein the set of levers includes a first lever and a second lever.

10. The hinge assembly of claim 8, wherein an element position of the resilient element and an end position of the lever input end can be moved laterally relative to one another in order to facilitate an adjustment in tolerances without affecting operation of the hinge assembly once the second hinge portion is biased away from the first hinge portion.

11. A spring assembly of a hinge assembly for a closure panel of a vehicle, the spring assembly comprising:
a spring support bracket for connecting to a bracket of the hinge assembly;
a spring mounted on the spring support bracket, the spring having an output end, the spring for biasing operation of the hinge assembly in order to move the closure panel towards an open position, the spring assembly including a holder mounted on the spring support bracket such that the holder is movable between an engaged position with the output end and a disengaged position with the output end;
wherein when the output end is engaged with input end, the spring assembly is mountable to the hinge assembly.

12. The spring assembly of claim 11, wherein the holder is mounted on a holder mount of a spring support bracket of the spring assembly, the holder is movable between a pre-position in which the output end is in said engaged position and an operational position in which the output end is in said disengaged position.

13. The spring assembly of claim 12, wherein the holder is mounted on the spring support bracket by a slot and track arrangement.

14. The spring assembly of claim 13, wherein the slot is positioned on the holder and the track is positioned on the holder mount, such that movement of the slot along the track facilitates movement of the holder between the pre-position and the operational position.

15. The spring assembly of claim 11 further comprising the holder having a pre-position tab and an operational tab, such that positioning of the output end on the pre-position tab results in said engaged position and positioning of the output end adjacent the operational tab results in said disengaged position.

16. The spring assembly of claim 15 further comprising a ramp separating the pre-position tab from the operational tab.

17. The spring assembly of claim 11 further comprising a spring adjustment mechanism for adjusting a position of an input end of the spring.

18. The hinge assembly of claim 11 further comprising a resilient element coupled to the holder, the resilient element for positioning in line with an end stop portion of a lever input end of the hinge assembly.

19. The hinge assembly of claim 18, wherein an element position of the resilient element and an end position of the lever input end can be moved laterally relative to one another in order to facilitate an adjustment in tolerances without affecting operation of the hinge assembly once the holder is placed in the disengaged position.

20. A method for assembling a hinge assembly including the steps of:
mounting a spring assembly onto a body bracket of the hinge assembly, the spring assembly having a spring mounted on a spring support bracket, the spring having an output end, the spring for biasing operation of the hinge assembly in order to move the closure panel towards an open position, the spring assembly including a holder positioned on the spring support bracket at a pre-position inhibiting engagement of the output end with a lever input end of the hinge assembly;
moving the holder on the spring support bracket from the pre-position to an operational position in order to engage the output end with the lever input end;
wherein subsequent movement of the hinge assembly is facilitated by said engage of the output end with the lever input end.
